(19) United States
(12) Patent Application Publication
(10) Pub. No.: US 2011/0046765 A1
(43) Pub. Date: Feb. 24, 2011

(54) INFORMATION PROCESSING DEVICE, INFORMATION PROCESSING METHOD, AND PROGRAM

(75) Inventor: Munetaka Yamagami, Amagasaki-shi (JP)

Correspondence Address: CANTOR COLBURN LLP, 20 Church Street, 22nd Floor, Hartford, CT, 06103, US

(73) Assignee: TOKYO ELECTRON LIMITED, Tokyo (JP)

(21) Appl. No.: 12/809,749

(22) PCT Filed: Dec. 17, 2008
(86) PCT No.: PCT/JP2008/072990

§ 371 Date: Jun. 21, 2010

(30) Foreign Application Priority Data
Dec. 21, 2007 (JP) 2007-329755

(51) Int. Cl. G06F 19/00

(52) U.S. Cl. 700/103

(57) ABSTRACT

An information processing device includes a target value receiving unit receiving one or more types of target values in a predetermined semiconductor manufacturing process; a parameter acquiring unit acquiring values of parameters during the semiconductor manufacturing process; an execution result acquiring unit acquiring one or more types of execution results indicating results of the semiconductor manufacturing process; an accumulation unit associating the execution results, the target values, and the values of parameters with one another and accumulating the same; a correlation acquiring unit acquiring correlation information indicating correlations among the execution results, the target values, and the values of parameters; an assist information acquiring unit acquiring assist information related to parameters with high correlation with respect to the target values received by the target value receiving unit by using the correlation information; and an output unit outputting the assist information acquired by the assist information acquiring unit.

### TECHNICAL FIELD

The present invention relates to an information processing device or the like that is used in a semiconductor manufacturing process or the like using a manufacturing device.

### BACKGROUND ART

As a conventional method of manufacturing a semiconductor device, a manufacturing process of the entire manufacturing processes of a semiconductor device includes a step of recording processing history and examination results in a previous manufacturing process, which has been performed prior to the manufacturing process, to a computer-readable storage medium and a step of determining processing conditions of the manufacturing process based on the processing history and examination results recorded in the storage medium. A structure in which these steps are performed by using at least one computer is known (e.g. refer to Japanese Patent Laid-Open Publication No. 2002-231596 (pg. 1, FIG. 1, etc.)).

However, in actual semiconductor manufacturing process, in even a same type of manufacturing devices, if different models have different characteristics or if targets of manufacturing are different, parameters to be adjusted may be significantly different and there may be little relationships among the parameters. Thus, it is difficult to full-automatically set processing conditions by using a computer or the like.

Therefore, a user acquires a desired process result by manually adjusting parameters or the like that are critical factors of a process.

Accordingly, in case of manually acquiring configuration of parameters for acquiring a desired result, it is technically preferable to allocate as many parameters as possible to perform experiments, but it may usually be difficult time-wise.

Therefore, at an actual experiment field, adjustment ranges of parameters or the like of a manufacturing device depend on experience and inspiration of a skilled personnel.

### DISCLOSURE OF THE INVENTION

### Technical Problem

However, since an adjustment range of parameters or the like of a manufacturing device depends on experience and inspiration of a skilled personnel in the prior art, there are problems in that know-how or the like of determining parameters are personalized and cannot be shared, parameters of a manufacturing device cannot be set to acquire a desired result without a skilled personnel, and it takes time due to necessity of repeating experiments or the like to acquire a desired result.

Therefore, it is very difficult for a user with insufficient experience to set parameters or the like of a manufacturing device to acquire a desired result. Furthermore, the quality of a product acquired from a manufacturing device may significantly depend on the skills of a user.

Furthermore, even if a user refers to parameter setting example which another user made, it takes much time to find parameter setting examples in which targets or the like are same. Also, suitable adjustments cannot be done even if an example of setting parameters for a different target is referred.

### Technical Solution

An information processing device according to the present invention includes a target value receiving unit, which receives one or more types of target values indicating targets in a predetermined semiconductor manufacturing process performed with respect to a target substrate by using a manufacturing device; a parameter acquiring unit, which acquires values of one or more types of parameters with respect to the manufacturing device for performing the semiconductor manufacturing process; an execution result acquiring unit, which acquires one or more types of execution results indicating results of performing the semiconductor manufacturing process; an accumulation unit, which associates the execution results acquired by the execution result acquiring unit, the target values received by the target value receiving unit, and the values of the parameters acquired by the parameter acquiring unit with one another and accumulates the same; a correlation acquiring unit, which acquires correlation information indicating correlations among the execution results, the target values, and the values of the parameters accumulated by the accumulation unit; an assist information acquiring unit, which acquires assist information related to parameters with high correlation with respect to the target values received by the target value receiving unit, by using the correlation information acquired by the correlation acquiring unit; and an output unit, which outputs the assist information acquired by the assist information acquiring unit.

Based on this configuration, parameters to be adjusted for acquiring an execution result close to current target value, values of the parameters, or the like may be shown to a user, and thus adjustment of values of parameters may be performed efficiently and quickly.

Furthermore, in the information processing device according to the present invention, the parameter acquiring unit acquires values of a plurality of types of parameters, the accumulation unit accumulates a plurality of sets of the execution results acquired by the execution result acquiring unit, the target values received by the target value receiving unit, and the values of the plurality of types of parameters acquired by the parameter acquiring unit, wherein the execution results, the target values, and the values of the plurality of types of parameters are associated with one another, the correlation acquiring unit acquires values indicating a difference between a target value and an execution result from each of the plurality of sets of the execution results, the target values, and the values of the plurality of types of parameters accumulated by the accumulation unit, and calculates the correlation information, which is a correlation coefficient between each of the values of the plurality of parameters and the value indicating the difference, by using a plurality of sets of the acquired value indicating the difference and values of a plurality of parameters corresponding to the value indicating the difference, and the assist information acquiring unit acquires assist information regarding one or more parameters with large correlation coefficients from among the plurality of parameters.

Based on this configuration, parameters with high correlation with respect to a target value, values of the parameters, or the like may be shown to a user, and thus adjustment of values of parameters may be performed efficiently and quickly.

Furthermore, in the information processing device according to the present invention, the assist information acquiring unit acquires the assist information which is the values of the one or more parameters with large correlation coefficients, that is, values of parameters corresponding to small differences between target values and execution results, from the values of the parameters accumulated by the accumulation unit.

Based on this configuration, parameters with high correlation with respect to a target value, values of the parameters, or the like may be shown to a user, and thus adjustment of values of parameters may be performed efficiently and quickly.

Furthermore, the information processing device according to the present invention further includes a user attribute acquiring unit, which acquires user attribute data that is a value indicating a attribute of a user who performs the semiconductor manufacturing process, wherein the accumulation unit associates the user attribute data with the execution results and accumulates the user attribute data, and the correlation acquiring unit acquires the correlation information by using the user attribute data.

Based on this configuration, user attribute data may be reflected to correlation information. Therefore, for example, only combinations of suitable values of parameters backed up by experience of a user may be reflected in assist information by using a value representing the degree of experience of the user as user attribute data, and thus assist information of high quality may be provided.

Furthermore, in the information processing device according to the present invention, the assist information acquiring unit acquires the assist information by using the user attribute data.

Based on this configuration, user attribute data may be reflected to assist information. Therefore, for example, by using a value indicating a degree of experience of a user as user attribute data, only combinations of suitable values of parameters backed up by experiences may be reflected to assist information, and thus assist information of high quality may be provided.

Furthermore, the information processing device according to the present invention further includes a user attribute acquiring unit, which acquires user attribute data that is a value indicating a attribute of a user who performs the semiconductor manufacturing process, wherein the accumulation unit associates the user attribute data with each of the sets of the execution results, the target values, and the values of the plurality of parameters and accumulates the user attribute data, and the correlation acquiring unit selects a plurality of sets of the execution results, the target values, and the values of the plurality of parameters, which are to be used to calculate the correlation coefficients, from the plurality of sets of the execution results, the target values, and the values of the plurality of parameters accumulated by the accumulation unit, by using the user attribute data corresponding to each of the plurality of sets, and calculates the correlation coefficients by using the selected sets.

Based on this configuration, user attribute data may be reflected to correlation information. Therefore, for example, by using a value indicating a degree of experience of a user as user attribute data, only combinations of suitable values of parameters backed up by experiences may be reflected to assist information, and thus assist information of high quality may be provided.

Furthermore, in the information processing device according to the present invention, the assist information acquiring unit acquires the assist information, which is the values of the one or more parameters with large correlation coefficients, that is, values of the parameters corresponding to small differences between target values and execution results, from the values of the parameters selected from among the values of the parameters accumulated by the accumulation unit, by using the user attribute data in association with the values of the parameters.

Based on this configuration, user attribute data may be reflected in assist information. Therefore, for example, by using a value indicating a degree of experience of a user as user attribute data, only combinations of suitable values of parameters backed up by experiences may be reflected to assist information, and thus assist information of high quality may be provided.

### ADVANTAGEOUS EFFECTS

According to an information processing device according to the present invention, adjustment of values of parameters in a semiconductor manufacturing process may be performed efficiently and quickly.

### BRIEF DESCRIPTION OF THE DRAWINGS

FIG. 1 is a block diagram of an information processing device according to an embodiment;

FIG. 2 is a concept view of a manufacturing device management system including the information processing device according to the present embodiment;

FIG. 3 is a diagram showing an example of a manufacturing device 200 according to the present embodiment;

FIG. 4 is a flowchart showing operations of the information processing device according to the present embodiment;

FIG. 5 is a diagram showing a management table according to the present embodiment;

FIG. 6 is a diagram showing an example of display of an input screen according to the present embodiment;

FIG. 7 is a diagram showing correlation information according to the present embodiment;

FIG. 8 is a diagram showing an example of display of assist information according to the present embodiment;

FIG. 9 is a diagram showing a management table according to the present embodiment;

FIG. 10 is a diagram showing an example of displaying assist information according to the present embodiment;

FIG. 11 is a diagram showing another management table according to the present embodiment;

FIG. 12 is a schematic diagram showing an example of the appearance of a computer system according to the present embodiment;

FIG. 13 is a diagram showing an example of the configuration of the computer system according to the present embodiment;

FIG. 14A is a diagram showing an example of the manufacturing device 200 according to the present embodiment; and

FIG. 14B is a diagram showing a part of the example of the manufacturing device 200 according to the present embodiment.

### BEST MODE FOR CARRYING OUT THE INVENTION

The present invention will now be described more fully with reference to the accompanying drawings, in which exemplary embodiments of the invention are shown. Furthermore, like reference numerals in the drawings denote like elements, and thus their description may be omitted.

### EMBODIMENTS

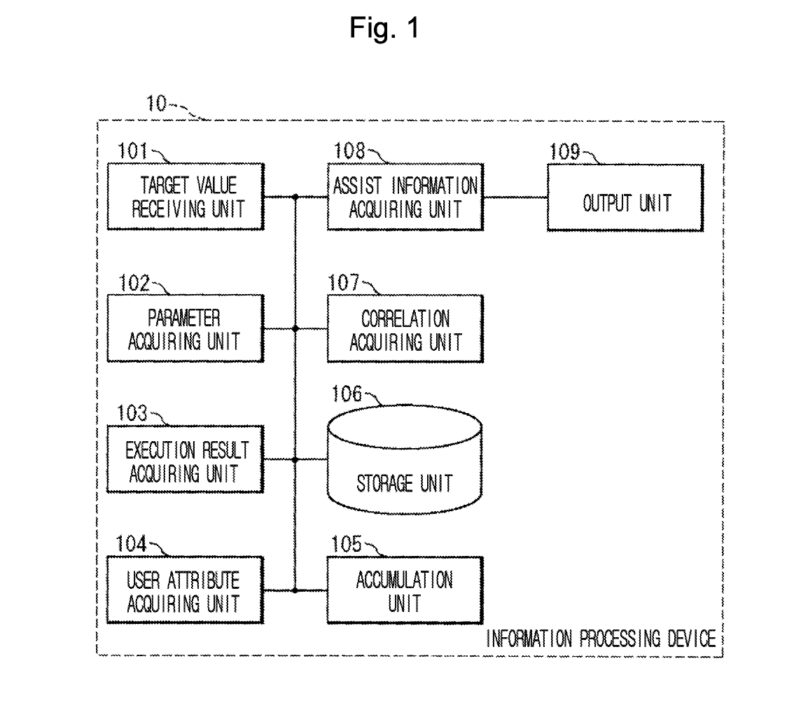

FIG. 1 is a block diagram of an information processing device according to the present embodiment.

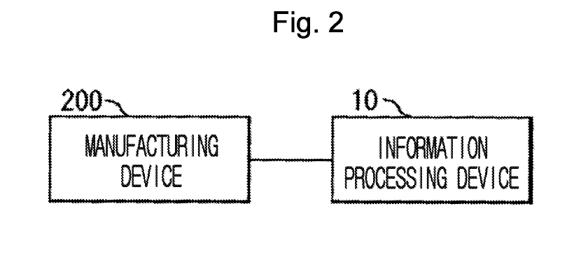

Furthermore, FIG. 2 is a concept view of a manufacturing device management system including the information processing device according to the present embodiment.

An information processing device 10 is directly or indirectly connected to a manufacturing device 200 via a communication line or the like, such that data may be transmitted and received. The information processing device 10 and the manufacturing device 200 may be connected via a network, e.g. the internet, wireless or wired LAN, or the like, or may be connected via a local area wireless communication, such as the Bluetooth (registered trademark) or the like. Furthermore, the information processing device 10 and the manufacturing device 200 may be directly connected to each other via a signal line. Furthermore, the information processing device 10 may be built in the manufacturing device 200. Furthermore, the information processing device 10 may be connected to a detecting device, which detects a result of processing a target substrate, or the like. Furthermore, the information processing device 10 may be connected to another information processing device, such as a server which collects information input with respect to the manufacturing device 200 or information output by the manufacturing device 200, so that the information processing device 10 may acquire information from the other information processing device.

FIG. 1 is a block diagram of an information processing device according to the present embodiment.

The information processing device 10 includes a target value receiving unit 101, a parameter acquiring unit 102, an execution result acquiring unit 103, a user attribute acquiring unit 104, an accumulation unit 105, a storage unit 106, a correlation acquiring unit 107, an assist information acquiring unit 108, and an output unit 109.

The target value receiving unit 101 receives one or more types of target values, which indicate target of a predetermined semiconductor manufacturing process performed with respect to a target substrate by using the manufacturing device 200. For example, the target values are target values with respect to results of processing a target object by the manufacturing device 200, where the target object herein is a target substrate. For example, the target values may be values indicating results of processes as target, or may be values indicating a non-uniform range of values of results of processes as target. For example, the target values may be a target value with respect to the thickness, quality, or the like of a film directly or indirectly formed on a target substrate by the manufacturing device 200, which is a film forming device, a depth or a shape by or in which etching is performed with respect to the target substrate, a film on the target substrate, or the like by the manufacturing device 200, which is an etching device, or the like. For example, the target value of the thickness of a film is a target value of different type as compared to the target value of the quality of the film. Furthermore, the target values may be values indicating non-uniform ranges of these values. In detail, the target value may be a value indicating the target of the thickness of a film formed by the manufacturing device 200, for example, 10 nm or the like. For example, a target value may be constructed of a combination of information indicating a target object and a value thereof or may be constructed of only a value. Furthermore, a target value may be a target value of a state of a process, such as processing time or the like. The target value receiving unit 101 may receive a plurality of types of target values. For example, the target value receiving unit 101 may receive a target value with respect to the thickness of a film and a target value with respect to the quality of the film. Furthermore, a target substrate may be a substrate used in a semiconductor device, e.g. a semiconductor wafer, a glass substrate for an organic film, a liquid panel substrate, or the like. The semiconductor manufacturing processes include, for example, film formation, etching, doping, thermal oxidation, and the like performed with respect to the target substrate. A semiconductor device manufactured using a target substrate is, for example, an integrated circuit, an organic EL display, a liquid crystal panel, or the like. The term “reception” used herein refers to, for example, reception from an input means, reception of an input signal transmitted by another device or the like, readout of information from a recording medium, or the like, or the like. A target value may be input via any of various means including a numeric keypad, a keyboard, a mouse, a menu screen, and the like. The target value receiving unit 101 may be embodied as a device driver for an input means, such as a numeric keypad, a keyboard, or the like, or as software for controlling a menu screen.

The parameter acquiring unit 102 acquires values of one or more types of parameters with respect to the manufacturing device 200 for performing semiconductor manufacturing processes. In detail, values of one or more types of parameters, and preferably, values of a plurality of types of parameters for performing semiconductor manufacturing processes are acquired to acquire the aforementioned target values. The values of parameters for performing semiconductor manufacturing processes are, for example, values of parameters in a recipe used by the manufacturing device 200 for performing semiconductor manufacturing processes, for example values of parameters for designating a process sequence, conditions for configuring the process sequence, or the like, or values of parameters of a device, for example, values of parameters which generally cannot be changed by a user, such as setup of a static heater or the like. Furthermore, the manufacturing device 200 may consider and acquire data such as values which cannot be controlled by the manufacturing device 200 during the semiconductor manufacturing processes, as values of parameters. The data which cannot be controlled by the manufacturing device 200 may be the amount of power to be supplied to the manufacturing device 200, a flow of a source gas, a flow of an exhausted gas, a temperature measured by the manufacturing device 200, and the like, for example, during a single semiconductor manufacturing process. The data which cannot be controlled by the manufacturing device 200 is acquired by the manufacturing device 200 by using one or more temperature sensors, one or more vibration sensors, one or more flow sensors, or the like. The data which cannot be controlled by the manufacturing device 200 also include data regarding differences of parts of the manufacturing devices 200, e.g. differences of slot antennas for generating plasma, or the like. Furthermore, for example, if objects to be controlled by values of parameters are different, the values of the parameters are considered as values of different types. For example, a set temperature of a first heater and a set temperature of a second heater are considered as values of parameters of different types. The parameter acquiring unit 102 may acquire values of parameters in any method. For example, the parameter acquiring unit 102 may acquire values of parameters by receiving the values of parameters input via an input means, such as a numeric keypad, a keyboard, a mouse, or the like. Furthermore, the parameter acquiring unit 102 may acquire values of parameters by receiving the values of parameters output by the manufacturing device 200 or the like. Furthermore, the parameter acquiring unit 102 may acquire values of parameters by reading out the values of parameters stored in a memory or the like. Values of parameters may be input via any of various input means, such as a numeric keypad, a keyboard, a mouse, a menu screen, or the like. The parameter acquiring unit 102 may be generally embodied as a device driver of an input means, such as a numeric keypad, a keyboard, or the like, a driver of a means for reading out data from a recording medium or the like, a driver of a communication means, software for controlling a menu screen, or the like. Furthermore, it may be configured that the values of parameters acquired by the parameter acquiring unit 102 are output to the manufacturing device 200 via an output unit (not shown) or the like and the manufacturing device 200 controls semiconductor manufacturing processes by using the values of the parameters output by the information processing device 10.

The execution result acquiring unit 103 acquires one or more execution results, which are values indicating results of performing semiconductor manufacturing processes. In detail, the execution result acquiring unit 103 acquires one or more execution results, which are values indicating results acquired when semiconductor manufacturing processes are executed by setting up the target values stated above and designating the values of the parameters stated above. The execution result acquiring unit 103 generally receives execution results corresponding to the target values received by the target value receiving unit 101. The execution results are values acquired from a target substrate processed with respect to the same items as those corresponding to the target values. In detail, in the case where the target value receiving unit 101 has received a target value with respect to the thickness of a film, the execution result acquiring unit 103 acquires an execution result, which is a measured value of the thickness of a film on a target substrate. The execution result acquiring unit 103 may acquire an execution result by using any of various methods. For example, the execution result acquiring unit 103 may acquire an execution result by receiving the execution result input via any of various input means, such as a numeric keypad, a keyboard, a mouse, or the like. Furthermore, the execution result acquiring unit 103 may acquire an execution result, which is a measured value output by a device for measuring a state or the like of a target substrate (not shown), e.g. a device for measuring the thickness or the like of a film formed on the target substrate. Furthermore, the execution result acquiring unit 103 may acquire an execution result by reading out the execution result stored in a memory or the like. An execution result may be input via any of various input means, such as a numeric keypad, a keyboard, a mouse, a menu screen, or the like. The execution result acquiring unit 103 may be generally embodied as a device driver of an input means, such as a numeric keypad, a keyboard, or the like, a driver of a means for reading out data from a recording medium or the like, a driver of a communication means, software for controlling a menu screen, or the like.

The user attribute acquiring unit 104 acquires user attribute data, which include values indicating attributes of a user who performs semiconductor manufacturing processes. The user performing semiconductor manufacturing processes is a user who inputs the aforementioned target values to the information processing device 10 and performs semiconductor manufacturing processes by using the manufacturing device 200. Examples of the user attribute data include identification information, such as a name, a personnel ID, an ID, or the like of a user, numeric values indicating a department or title of a user or a number of years of service or experience of the user, numeric values indicating a number of experience years of a manufacturing device used by a user, and the like. Furthermore, in the case where user attribute data is not used, the user attribute acquiring unit 104 may not be included. The user attribute acquiring unit 104 may acquire user attribute data by using any of various methods. For example, the user attribute acquiring unit 104 may acquire user attribute data received by a receiving unit (not shown) or the like. Furthermore, the user attribute acquiring unit 104 may acquire user attribute data by searching for user attribute data corresponding to user ID received by a receiving unit (not shown) in a database (not shown) or the like. Furthermore, the user attribute acquiring unit 104 may acquire user attribute data by searching for user attribute data corresponding to a user ID of a user, who is logged into the information processing device 10 at the time of inputting the aforementioned target values or the like, in a database (not shown) by using the user ID of the user as a searching keyword. Alternatively, a user ID of a user, who is currently operating the manufacturing device 200, or the like may be transmitted to the manufacturing device 200 and user attribute data corresponding to the user ID may be read out. User attribute data may be input via any of various input means, such as a numeric keypad, a keyboard, a mouse, a menu screen, or the like. The user attribute acquiring unit 104 may be generally embodied as a device driver of an input means, such as a numeric keypad, a keyboard, or the like, a driver of a means for reading out data from a recording medium or the like, a driver of a communication means, software for controlling a menu screen, or the like. Furthermore, in the case where a process, e.g. search, is necessary, the user attribute acquiring unit 104 may be embodied with a MPU, a memory, or the like. In this case, the processing sequence of the user attribute acquiring unit 104 is generally embodied as software, and the software is recorded in a recording medium, such as a ROM. However, the processing sequence of the user attribute acquiring unit 104 may also be embodied as hardware (exclusive circuitry).

The accumulation unit 105 associates one or more execution results acquired by the execution result acquiring unit 103, one or more target values, and values of one or more types of parameters acquired by the parameter acquiring unit 102 with one another and accumulates the same. In detail, the accumulation unit 105 associates target values, values of parameters, and execution results with respect to a same semiconductor manufacturing process with one another and accumulates the same. The term “associating and accumulating” refers to accumulation of execution results, target values, and values of parameters as different attribute values of a same record, for example. Alternatively, it may be understood as accumulating data identifying execution results, data identifying target values, and data identifying values of parameters as different attribute values of a same record. Furthermore, the term “associating and accumulating” may be understood as accumulating an execution result, a target value, and a value of a parameter, which are associated with one another, as a set. Furthermore, the accumulation unit 105 may associate user attribute data with execution results acquired by the execution result acquiring unit 103, like as with target values or the like, and accumulate the same. Furthermore, user attribute data and execution results may be associated with each other and accumulated as a result, and, for example, user attribute data may be associated with target values or values of parameters corresponding to execution results and accumulated. Furthermore, the association of user attribute data and execution results with each other may be understood as association of target values and values of parameters, which correspond to the execution results, with the user attribute data. The accumulation unit 105 may include a storage unit or the like, in which execution results, target values, values of parameters, and user attribute data are accumulated, or execution results, target values, values of parameters, and user attribute data may be accumulated in an external storage unit or the like. Here, a case, in which the accumulation unit 105 accumulates the above-described data in the storage unit 106, which will be described below, will be described. The accumulation unit 105 may generally be embodied with a MPU, a memory, or the like. The processing sequence of the accumulation unit 105 is generally embodied as software, and the software is recorded in a recording medium, such as a ROM. However, the processing sequence of the accumulation unit 105 may also be embodied as hardware (exclusive circuitry).

The storage unit 106 stores one or more types of execution results, one or more types of target values, and values of one or more types of parameters (a plurality of types, preferably), which are associated with one another by the accumulation unit 105. Furthermore, execution results, target values, values of target values, and user attribute data, which are associated with one another, may be stored therein. Physically, there may be one or more storage units 106. The storage unit 106 may be embodied as a volatile or non-volatile recording medium or the like.

The correlation acquiring unit 107 acquires correlation information, which is information related to correlations among the one or more types of execution results, the one or more types of target values, and the values of one or more types of parameters, which are accumulated by the accumulation unit 105. In detail, the correlation acquiring unit 107 acquires correlation information by using one or more sets of execution results, target values, and values of parameters that are associated with one another. Furthermore, the correlation acquiring unit 107 may acquire correlation information by using one or more sets of execution results, target values, and values of parameters that are associated with one another, where the target values are identical or similar to each other, for example, the target values are within a predetermined range. Being the target values similar to each other may be understood as that the target values belong to a same item and are within a predetermined range. However, it is not important how to determine that the target values are similar to each other. Furthermore, the correlation acquiring unit 107 may acquire a current, that is, the newest target value received by the target value receiving unit 101 and acquire correlation information by using one or more sets of execution results, target values, and values of parameters, which are associated with a target value identical or similar to the received newest target value.

The correlation information is information indicating correlation among execution results, target values, and values of parameters, for example. Correlation information may be information indicating range, existence, or the like of correlations among execution results, target values, and values of parameters, information indicating range, existence, or the like of correlations between items of data generated based on the data above, or information acquired or generated by using range or existence of the correlations. A range of correlation may be understood as a range of the degree of correlation, e.g. a range of an absolute value of a correlation coefficient. Correlation information may be information indicating correlation of a difference between an execution result and a target value with each of parameters, for example. Alternatively, correlation information may be information indicating a type of parameter having a high correlation from among information indicating correlation of a difference between an execution result and a target value with each parameter. Here, the term “difference” used herein may refer to a value indicating a difference, and may be understood as a difference between an execution result and a target value, for example, or as an absolute value of the difference. Furthermore, a difference may be an index value or a standardized value. Here, the term “difference” used herein generally refers to a difference between a target value and an execution result of a same type. The correlation acquiring unit 107 acquires a correlation of each parameter with respect to a difference between an execution result and a target value, for example. Then, parameters which greatly affect the difference between the execution result and the target value, that is, parameters with high correlations, are determined based on the acquired correlations. Then, information indicating the types, that is, the items of the parameters which greatly affect the difference between the execution result and the target value are acquired as correlation information. Alternatively, a value of the parameter corresponding to the smallest difference between the execution result and the target value from among the values of the greatly affecting parameters may be acquired as correlation information. Range or existence of the correlation among the execution result, the target value, and the parameter is determined by using a correlation coefficient, for example.

For example, the correlation acquiring unit 107 calculates a correlation coefficient between a difference between an execution result and a target value and each parameter. In detail, if the parameter acquiring unit 102 acquires values of a plurality of types of parameters and the accumulation unit 105 accumulates a plurality of sets of the execution result acquired by the acquiring unit 103, the target value received by the target value receiving unit 101, and the values of the plurality of types of parameters (e.g. a value of gas flow, a value of a processing temperature, etc.) acquired by the parameter acquiring unit 102, the correlation acquiring unit 107 acquires a value indicating a difference between the target value and the execution result, e.g. a value of a difference, from each of the plurality of sets of the execution result, the target value, and the plurality of types of parameters, which are associated with one another and accumulated by the accumulation unit 105, and calculates a correlation coefficient between each of the plurality of types of parameters and the value indicating the difference by using a plurality of sets of the value indicating the difference and the values of the plurality of types of parameters corresponding to the value indicating the difference. For example, with respect to one type of parameters from among a plurality of types of parameters, a correlation coefficient between the parameters and the values of differences are calculated based on values of the parameters and the values of differences calculated above. In the same regard, correlation coefficients with respect to values of differences are calculated with respect to parameters of the other types. The terminology “value indicating a difference between a target value and an execution result” refers to a value indicating a difference between a target value and an execution result of a same type such as a same measuring item or the like. The terminology “a plurality of types of parameters associated with the value indicating the difference” refers to a plurality of types of parameters associated with a target value and an execution value used to calculate the difference. The terminology “calculation of a correlation coefficient between each of a plurality of types of parameters and the value indicating the difference” refers to calculation of a correlation coefficient between each of the plurality of types of parameters and the value indicating the difference. For example, if there are a parameter 1 and a parameter 2, a correlation coefficient between the parameter 1 and the value indicating the difference and a correlation coefficient between the parameter 2 and the value indicating the difference are calculated.

The correlation acquiring unit 107 may use the calculated correlation coefficients as correlation information. Alternatively, the correlation acquiring unit 107 determines one or more types of parameters greatly affecting the difference between the execution result and the target value based on the calculated correlation coefficients. In detail, one or more types of parameters with relatively large correlation coefficients are determined. For example, the one or more types of parameters with relatively large correlation coefficients may be parameters with correlation coefficients greater than a threshold value, or a predetermined number of parameters selected from among parameters with relatively large correlation coefficients in a descending order of correlation coefficients, or a predetermined proportion of parameters selected from among parameters with relatively large correlation coefficients in the descending order of correlation coefficients. The correlation coefficients greater than a threshold value may or may not include the threshold value. Furthermore, a threshold value may be a pre-set value or may be determined based on the acquired correlation coefficients. In the latter case, the threshold value may be a value acquired by multiplying the largest correlation coefficient by a value smaller than 1 (e.g. 0.9). Furthermore, information indicating the item of the parameters greatly affecting the difference between the execution result and the target value may be acquired as correlation information. Alternatively, from among the values of the parameters greatly affecting the difference between the execution result and the target value, a value of the parameter corresponding to the smallest difference between the execution result and the target value may be acquired as correlation information. Since a method of calculating the correlation coefficient is well-known in the art, a detailed description thereof will be omitted.

Furthermore, the correlation acquiring unit 107 may determine a parameter with a high correlation with respect to a difference between an execution result and a target value by using a different multi-variate analysis. Furthermore, in the case where a plurality of types of target values and a plurality of types of execution results are included in one or more sets of execution results, target values, and parameters that are associated with one another, correlations with respect to one or more types of parameters per each of sets of target values and execution results in association with each other may be acquired, parameters greatly affecting the differences between the execution results and the target values may be determined, and information indicating items of the parameters greatly affecting the differences between the execution results and the target values may be acquired as correlation information.

Furthermore, the correlation acquiring unit 107 may acquire correlation information by using user attribute data. In detail, correlation information may be acquired by performing weight evaluation with respect to target values, execution results, or values of parameters, which correspond to the user attribute data, according to values of the user attribute data. For example, the correlation acquiring unit 107 may acquire a value indicating a number of years of experience of using a manufacturing device to which parameters are to be set, from the user attribute data, and perform weight evaluation with respect to target values, execution results, or parameters corresponding to the user attribute data according to the value indicating the years of experience of using the manufacturing device, thereby acquiring correlation information. For example, if the number of years of experience of using the manufacturing device is less than a predetermined number of years, target values, execution results, or parameters corresponding to the user attribute data may not be used to acquire correlation information. In other words, an evaluated weight may be zero. Alternatively, for example, based on user attribute data indicating a manufacturing device having been used by a user, it may be determined whether target values, execution results, or parameters corresponding to the user attribute data are to be used to acquire correlation information. For example, when correlation information with respect to one or more types of execution results, one or more types of target values, and values of one or more parameters, which are accumulated by the accumulation unit 105, is acquired, sets of one or more execution results, one or more target values, and values of one or more parameters, which correspond to user attribute data including no information indicating experience of using a manufacturing device identical or almost identical to a manufacturing device to which the parameters are to be set, may not be used. In detail, the correlation acquiring unit 107 may select a plurality of sets of the execution results, the target values, and the values of the plurality of parameters which are to be used to calculate the correlation coefficients, from the plurality of sets of the execution results, the target values, and the values of the plurality of parameters which are associated with one another and accumulated by the accumulation unit 105, by using the user attribute data corresponding to each of the plurality of sets accumulated by the accumulation unit 105, and may calculate the correlation coefficients by using the selected sets. The terms “by using user attribute data” and “select” refer to selection based on a result of a determination as to whether a value of the user attribute data satisfies a predetermined condition or not, for example. Furthermore, the correlation coefficients may be calculated by performing weight evaluation based on user attribute data by changing a number of times of using a plurality of sets of execution results, target values, and values of a plurality of types of parameters according to the user attribute data. For example, in the case where user attribute data indicates that the user is a user with sufficient experiences, a plurality of sets of execution results, target values, and values of a plurality of parameters corresponding to the user are prepared according to the length of the experience, On the other hand, in the case where user attribute data indicates that the user is a user with insufficient experiences, only one set of execution results, target values, and values of a plurality of parameters corresponding to the user is prepared according to the length of the experience. Then, by calculating correlation coefficients based on the prepared plurality of sets of execution results, target values, and values of a plurality of parameters, a correlation coefficient, in which values corresponding to the user with sufficient experiences are highly weighted, may be acquired as a result. In detail, correlation coefficients which are weighted based on a number of years of experiences may be acquired by preparing a plurality of sets of execution results, target values, and values of a plurality of parameters for each of users on the basis of the number of years of experiences of the each of users and acquiring correlation coefficients based on data of the plurality of sets. Furthermore, the correlation information or the like acquired by the correlation acquiring unit 107 is accumulated in a storage medium (not shown), such as a memory or the like. The correlation acquiring unit 107 may generally be embodied with a MPU, a memory, or the like. The processing sequence of the correlation acquiring unit 107 is generally embodied as software, and the software is recorded in a recording medium, such as a ROM. However, the processing sequence of the correlation acquiring unit 107 may also be embodied as hardware (exclusive circuitry).

The assist information acquiring unit 108 acquires assist information, which is information regarding parameters with high correlation with respect to the target values received by the target value receiving unit 101, by using the correlation information acquired by the correlation acquiring unit 107. The terms “parameters with high correlation with respect to target values” refers to parameters with high correlation with a difference between a target value identical or similar to the current (or the newest) target value and an execution result. In detail, the assist information acquiring unit 108 generates assist information by using correlation information acquired with respect to a target value identical or similar to the current target value received by the target value receiving unit 101, for example, a target value in a predetermined range with respect to the current target value. In detail, the assist information refers to information displayed to a user to show parameters with high correlation with respect to the current target value, and is, for example, information for displaying information which may be used to assist the user to set the parameters used to acquire a target value, that is, information for displaying assisting information. In detail, assist information is information indicating parameters with high correlation or information representing examples of set values of the parameters, in order to indicate parameters to be adjusted to acquire an execution result close to a target value. For example, the assist information acquiring unit 108 acquires values of parameters having high correlation with a difference between a target value and an execution result, which is as indicated by correlation information, as assist information from a plurality of sets corresponding to small differences between a target value and an execution result from among the sets of target values, execution results, and values of parameters corresponding to a target value identical or similar to the current target value, that is, a target value existing in a predetermined range with respect to the current target value. In detail, the assist information acquiring unit 108 acquires assist information, which is the values of one or more types of parameters with large correlation coefficients acquired by the correlation acquiring unit 107, that is, values of parameters corresponding to relatively small differences between target values and execution results, from the values of parameters accumulated by the accumulation unit 105. The term “values of parameters corresponding to relatively small differences” may refer to, for example, values of parameters corresponding to difference values smaller than a threshold value, a predetermined number of parameters selected starting from a parameter corresponding to a relatively small difference in an ascending order of the difference, or a predetermined proportion of parameters selected starting from a parameter corresponding to a relatively small difference in an ascending order of the difference. The difference values smaller than the threshold value may or may not include the threshold value. Furthermore, a threshold value may be a pre-set value or may be determined based on acquired values corresponding to differences, for example. In the latter case, the threshold value may be a value acquired by multiplying the largest value corresponding to the difference by a value smaller than 1 (e.g. 0.9).

The assist information acquiring unit 108 may acquire assist information by using user attribute data. For example, the assist information acquiring unit 108 may acquire assist information, which is values of one or more types of parameters with large correlation coefficients, that is, values of parameters corresponding to relatively small differences between a target value and a execution result, from values of parameters selected by using user attribute data associated with the values of the parameters accumulated by the accumulating unit 105 from among the values of the parameters accumulated by the accumulating unit 105. The term “select by using user attribute data” refers to selection based on a result of a determination as to whether a value of the user attribute data satisfies a predetermined condition or not, for example. In detail, information stored in the storage unit 106 may be filtered according to a determination as to whether the information is used to generate assist information according to user attribute data corresponding to the information. For example, assist information acquiring unit 108 may acquire, as assist information, information indicating types of parameters with high correlations and values of parameters or the like of sets, which correspond to target values identical or close to the current target value and correspond to user attribute data with large values for numerical indications of experiences of a user such as years of service of the user, from among the sets of execution results, target values, and values of parameters, which are stored in the storage unit 106. Alternatively, based on the name, the position, or the like of a user, values of parameters or the like corresponding to the user may be filtered so that the values of parameters or the like are not output as assist information. Furthermore, assist information may be generated simply by acquiring correlation information corresponding to target values received by the target value receiving unit 101, more particularly, correlation information corresponding to target values identical or similar to the target value acquired by the target value receiving unit 101 from among the correlation information acquired by the correlation acquiring unit 107 and arranging the acquired correlation information in, for example, information indicating templates so as to configure information to be displayed. A time point or a trigger for the assist information acquiring unit 108 to acquire assist information is not important. For example, the assist information acquiring unit 108 may acquire assist information if a target value, values of parameters, and an execution result are respectively received or acquired, or user attribute data is additionally acquired, or may acquire assist information in the case where an instruction to display assist information is received from a user or at the moment when a target value is input. Furthermore, the assist information acquiring unit 108 may acquire assist information only if a difference between the newest target value and the newest execution result is out of a pre-set range. The assist information acquiring unit 108 may generally be embodied with a MPU or a memory. The processing sequence of the assist information acquiring unit 108 is generally embodied as software, and the software is recorded in a recording medium, such as a ROM. However, the processing sequence of the assist information acquiring unit 108 may also be embodied as hardware (exclusive circuitry).

The output unit 109 outputs assist information acquired by the assist information acquiring unit. Here, the term “output” stated herein includes displaying on a display device, printing on a paper by using a printer, transmission to an external device, or the like. The output unit 109 may be considered as including or not including an output device, such as a display device, a printer, or the like. The output unit 109 may be embodied as driver software of an output device or as driver software of an output device and the output device or the like.

The manufacturing device 200 is a device for performing a predetermined semiconductor manufacturing process with respect to a target substrate, e.g. a semiconductor wafer, a glass substrate for an organic film, a liquid crystal panel substrate, or the like. The manufacturing device 200 performs various processes, e.g. film formation, etching, thermal oxidation, and the like, with respect to a target substrate. The manufacturing device 200 is a manufacturing device, such as a semiconductor wafer manufacturing device, or an organic EL display film-forming device, a liquid crystal panel manufacturing device, a plasma display panel manufacturing device, or the like.

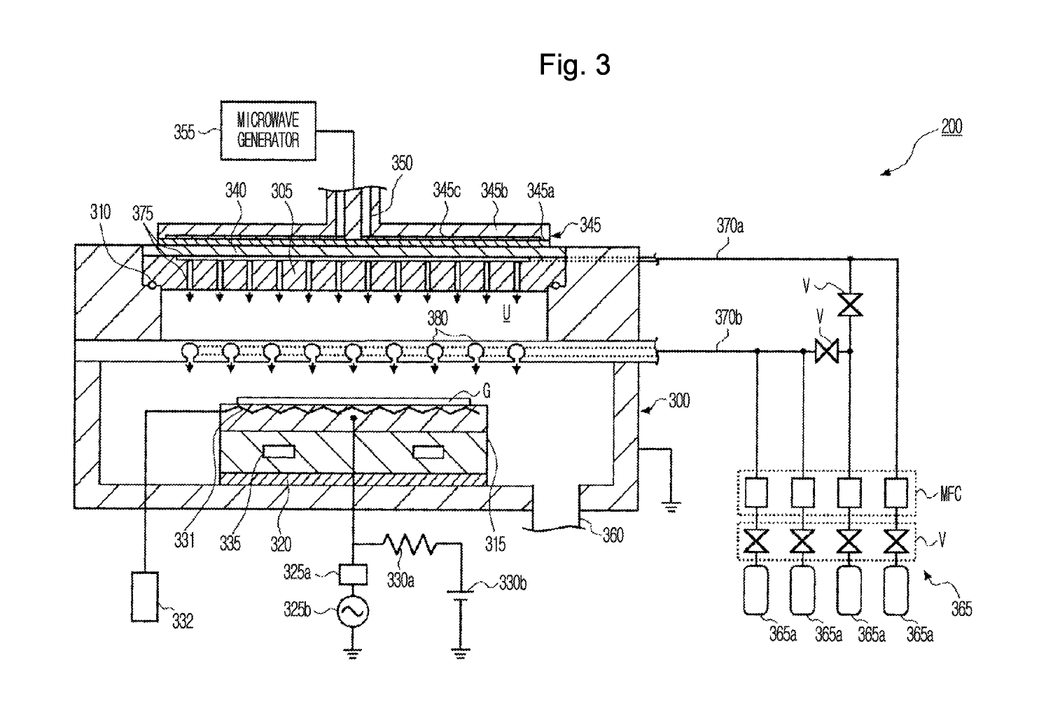

FIG. 3 is a diagram showing an example of the manufacturing device 200. Here, although descriptions are given with respect to the case where the manufacturing device 200 is a RLSA (radial line slot antenna) plasma CVD device, the manufacturing device 200 may be a different device.

An RLSA plasma CVD device includes a cylindrical processing container 300 where an opening is formed in the ceiling. A shower plate 305 is inserted into the opening of the ceiling. The processing container 300 and the shower plate 305 are sealed by an O-ring 310 installed between a stepped part of an inner wall of the processing container 300 and a bottom circumference part of the shower plate 305, and thus a processing chamber U in which a plasma process is performed is formed. For example, the processing container 300 is formed of a metal, such as aluminum, and the shower plate 305 is formed of a metal, such as aluminum, or a dielectric material and the processing container 300 and the shower plate 305 are electrically grounded.

A susceptor (holding stage) 315, on which a wafer W is held, is installed at a bottom part of the processing container 300 via an insulator 320. A radio frequency power supply source 325b is connected to the susceptor 315 via a matcher 325a, so that a predetermined bias voltage is applied into the processing container 300 by radio frequency power output by the radio frequency power supply source 325b. Furthermore, a high voltage direct current power supply source 330b is connected to the susceptor 315 via a coil 330a, and thus a substrate G is electrostatically absorbed by using a direct current voltage output from the high voltage direct current power supply source 330b. Furthermore, a heater 331 is installed in the susceptor 315, so that the wafer W is heated by power supplied from a heater power source 332. Furthermore, a cooling jacket 335, which supplies a coolant to cool the wafer W, is provided in the susceptor 315.

The shower plate 305 is covered from above by a cover plate 340. A radial line slot antenna 345 is disposed on the top surface of the cover plate 340. The radial line slot antenna 345 includes a disc-shaped slot plate 345a, in which a plurality of slots (not shown) are formed, a disc-shaped antenna body 345b, which supports the slot plate 345, and a wavelength-shortening plate 345c, which is disposed between the slot plate 345a and the antenna body 345b and is formed of a dielectric material, such as alumina (Al₂O₃). For example, radial line slot antennas 345 having various sizes, e.g. small and large, or various slot patterns, e.g. pattern A, pattern B, and so on, are prepared, and thus the radial line slot antenna 345 may be replaced based on purposes or the like. A microwave generator 355 is externally installed to the radial line slot antenna 345 via a coaxial waveguide 350.

A vacuum pump (not shown) is attached to the processing container 300 to depressurize the processing chamber U to a desired vacuum level by discharging gas from the processing container 300 via a gas exhaust pipe 360.

A gas supply source 365 includes a plurality of valves V, a plurality of mass flow controllers MFC, and a plurality of source gas supply source 365a, which supply one or more types of first source gases and one or more types of second source gases. The gas supply source 365 controls opening and closing of each of the valves V and an opening degree of each of the mass flow controllers MFC, so as to supply a gas of a desired concentration into the processing container 300. Accordingly, the first source gas passes a first flow path 370a and is supplied to an upper portion of the processing chamber U from a gas introducing pipe 375 which penetrates the shower plate 305, whereas the second source gas passes a second flow path 370b and is supplied to a portion of the processing chamber U, which is a portion below the portion to which the first source gas is supplied, from an integrated gas pipe 380. According to the configuration, plasma is generated from various gases by microwaves which have transmitted into the processing chamber U from the microwave generator 355 via the slots and the shower plate 305, and a film is formed on a substrate by the generated plasma.

The manufacturing device 200 also includes a control unit (not shown). The control unit controls various operations of the manufacturing device 200 according to a pre-set values of parameters of recipe which sets up conditions of processing a target object, or values of static parameters, which are pre-set with respect to the manufacturing device 200 and, generally, cannot be changed by a user, or the like. For example, in the case where a processing temperature is set, the control unit performs so-called feedback control with respect to the output of a heater or the like, based on a temperature detected by one or more temperature detecting units (not shown), such that the internal temperature of the processing container 300 becomes a set temperature. Furthermore, the control unit controls the internal pressure of the processing container 300 such that the internal pressure of the processing container 300 becomes a set pressure. For example, such controls may be performed by using pre-stored reference values as target values of the controls. Furthermore, although the control unit also controls the overall operations of the manufacturing device 200 other than the operations stated above, e.g. controlling a gas flow, controlling opening and closing of a valve, or the like, these controlling operations are well-known in the art, and thus detailed descriptions thereof will be omitted. Values of the parameters are accumulated in a storage medium (not shown), such as a memory, and are read out by the control unit as an occasion demands. The accumulation also includes temporary storage. It is not important how values of the parameters are received and are accumulated in a storage medium or the like. For example, values of parameters, which are input by a user or the like via a receiving unit (not shown) or the like of the manufacturing device 200, may be accumulated in a storage medium. Values of parameters output by another device, such as the information processing device 10, may be received by the receiving unit (not shown) of the manufacturing device 200 and may be accumulated in a storage medium or the like. Furthermore, the control unit may directly receive values of parameters and control operations instead of accumulating the values of the parameters. Furthermore, the control unit may output information detected by a temperature detecting unit (not shown) or the like to the information processing device 10 via an output unit (not shown) or the like. The control unit may generally be embodied with a MPU or a memory. The processing sequence of the control unit is generally embodied as software, and the software is recorded in a recording medium, such as a ROM. However, the processing sequence of the control unit may also be embodied as hardware (exclusive circuitry).

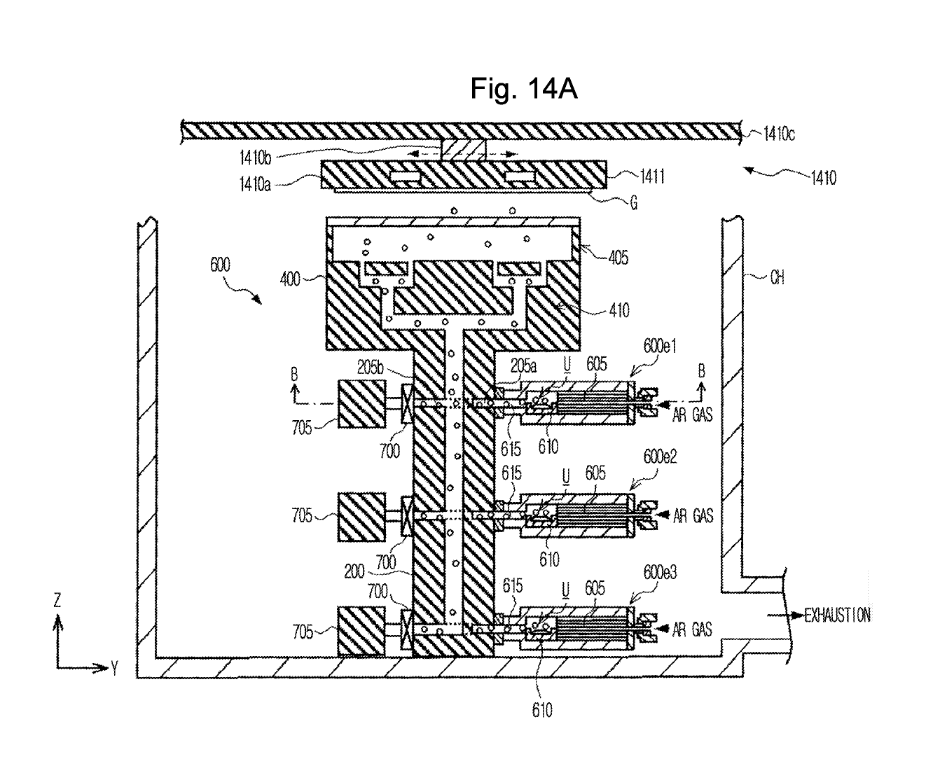

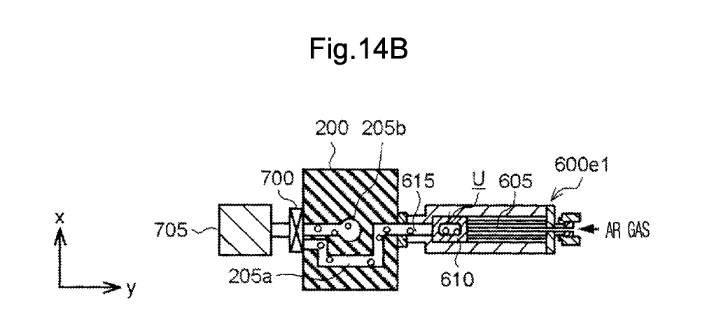

Furthermore, FIG. 14A and FIG. 14B are diagrams showing other examples of the manufacturing device 200. FIG. 14A and FIG. 14B show a case in which the manufacturing device 200 is an organic film forming device, which is used for forming organic films.

As shown in FIG. 14A, evaporating source units 600e1 through 600e3 have a same internal structure. An end of an evaporating source unit 600e is connected to an argon gas supply source (not shown), such that argon gas output by the argon gas supply source is supplied into the evaporating source unit 600e. The supplied argon gas flows through a plurality of gas flow paths formed in multiple stages in a gas supplying mechanism 605 and then flows into a first source vaporizing chamber U. In the first source vaporizing chamber U, an organic film forming source is stored in a source container 610, and the organic film forming source is vaporized by heating the source container 610.

The vaporized organic film forming source flows a transfer path 615 toward a transporting mechanism 200 by using the argon gas, which is introduced into the first source vaporizing chamber U, as a carrier gas. As shown in FIG. 14B, which shows a cross-section of a evaporating mechanism along a plane B-B′ of FIG. 14A, organic molecules and carrier gas, which have passed the transfer path 615, proceed from a detour 205a of a transporting path formed in the transporting mechanism 200 to a main path 205b of the transporting path via a valve 700, and, as shown in FIG. 14B, are transferred to an extracting mechanism 400.

A lever 705 for opening or closing the valve 700 is installed to the valve 700, and thus, if the valve 700 is closed by the lever 705, a film forming source and carrier gas are blocked by the valve 700 and are no further transported. When the valve 700 is opened by the lever 705, the film forming source and the carrier gas pass the valve 700 and are transported to the main path 205b of the transporting path. Accordingly, only organic molecules required for forming a film from among organic molecules vaporized at the evaporating source units 600e1 through 600e3 pass through the main path 205b of the transporting path, are mixed while the organic molecules pass through the main path 205b, and are transported to the extracting mechanism 400.

The extracting mechanism 400 includes an extracting unit 405 in the upper portion, and includes a branched path 410 in the lower portion. The extracting unit 405 has a hollow space S, and has an opening which is formed at the center of the top surface of the extracting unit 405 to extract film-forming molecules (not shown). Organic molecules transported to the extracting mechanism 400 by a carrier gas pass one of branched paths 410, which are branched into four paths by stages to equalize distances from the branch source to the branch targets so as to equalize conductances of the carrier gas and organic molecules passing the branched paths 410, and are extracted from an opening communicating with the space S of the extracting unit 405 toward the substrate G.

The sliding mechanism 1410 includes a stage 1410a, a supporting body 1410b, and a sliding structure 1410c. The stage 1410a is supported by the supporting body 1410b and electrostatically absorbs the substrate G by using high voltage power applied from a high voltage power supply source (not shown). The sliding structure 1410c is installed to the ceiling of a processing container CH and is grounded, for example, and thus slides the substrate G together with the stage 1410a and the supporting body 1410b in the lengthwise direction of the processing container CH, and thus the sliding structure 1410c moves the substrate G horizontally slightly above the extracting mechanism 400. Furthermore, a cooling jacket 1411, which supplies a coolant to cool a substrate, is formed in the stage 1410a.

Furthermore, in the manufacturing device 200 according to the embodiment, a control unit (not shown) may be formed as in the manufacturing device described above with reference to FIG. 3.

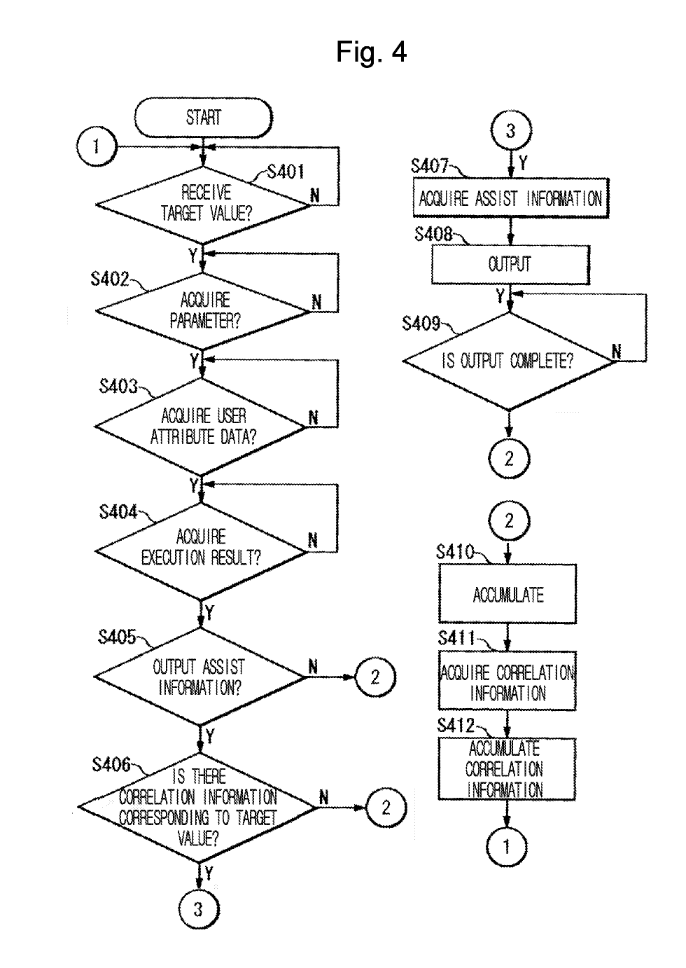

Next, the operation of an information processing device will be described with reference to the flowchart shown in FIG. 4.

(Step S401) The target value receiving unit 101 determines whether one or more types of target values are received or not. If one or more types of target values are received, the target values are temporarily stored in a storage medium, such as a memory, and the operation proceeds to a step S402, and, if no target value is received, the operation proceeds back to the step S401.

(Step S402) The parameter acquiring unit 102 determines whether values of one or more types of parameters are received or not. If values of one or more types of parameters are received, the values of the parameters are temporarily stored in a storage medium, such as a memory, and the operation proceeds to a step S403, and, if no value is received, the operation proceeds back to the step S402.

(Step S403) The user attribute acquiring unit 104 determines whether user attribute data are received or not. If user attribute data are received, the user attribute data are temporarily stored in a storage medium, such as a memory, and the operation proceeds to a step S404, and, if no value is received, the operation proceeds back to the step S403. Furthermore, in the case where the user attribute acquiring unit 104 is omitted, the present step is omitted.

(Step S404) The execution result acquiring unit 103 determines whether execution results corresponding to all of the target values received in the step S401 are received or not. If the execution results corresponding to all of the target values received in the step S401 are received, the execution results are temporarily stored in a storage medium, such as a memory, and the operation proceeds to a step S405, and, if no execution result is received, the operation proceeds back to the step S404.

(Step S405) The assist information acquiring unit 108 determines whether to output assist information or not. For example, it may be determined whether to output assist information, in the case where an instruction to output the assist information is received from a user via a receiving unit (not shown) or only in the case where a difference between the target values received in the step S401 and the execution results acquired in the step S404 exceeds a predetermined range, for example, a predetermined proportion. Furthermore, it may be determined whether to output assist information or not based on the user attribute data acquired in the step S403. For example, it may be determined whether to output assist information, only in the case where the user attribute data indicates that a number of experience years of a user for using the manufacturing device 200 is not more than a predetermined number of years or only in the case where a number of times that the manufacturing device 200 has been used in the current log-in is not more than a predetermined number of times. If it is determined to output assist information, the operation proceeds to a step S406, and, if it is determined not to output assist information, the operation proceeds to a step S410. Furthermore, in the case where it is configured to output assist information all the time, the present step may be omitted.

(Step S406) The assist information acquiring unit 108 determines whether correlation information acquired by the correlation acquiring unit 107 includes correlation information corresponding to a target value acquired in the step S101, that is, correlation information corresponding to a target value identical or similar to the target value acquired in the step S101. If the correlation information acquired by the correlation acquiring unit 107 includes the correlation information corresponding to the target value acquired in the step S101, the operation proceeds to a step S407, and, if the correlation information acquired by the correlation acquiring unit 107 includes no correlation information corresponding to a target value acquired in the step S101, the operation proceeds to the step S410.

(Step S407) The assist information acquiring unit 108 acquires correlation information corresponding to the target value acquired in the step S101 from the correlation information acquired by the correlation acquiring unit 107 and thus generates assist information.

(Step S408) The output unit 109 outputs assist information generated by the assist information acquiring unit 108. For example, the output unit 109 displays assist information on a monitor (not shown) or the like.

(Step S409) The output unit 109 determines whether to terminate the output of assist information or not. For example, it may be determined whether to output assist information, in the case where an instruction to terminate output of assist information, an instruction to perform input to modify values of parameters, or other instructions is received from a user. Furthermore, it may be determined whether to output assist information, in the case where a predetermined period of time has passed since the output of assist information has begun. In case of terminating the output of assist information, the operation proceeds to the step S410, and, in case of not terminating the output of assist information, the operation proceeds back to the step S409.

(Step S410) The accumulation unit 105 associates target values, values of parameters, user attribute data, and execution results, which are received or acquired in the steps S401 through S404, with one another and accumulates the target values, the values of parameters, the user attribute data, and the execution results in the storage unit 106.

(Step S411) The correlation acquiring unit 107 acquires correlation information by using a set of the target value, the values of parameters, the user attribute data, and the execution result, which are accumulated in the step S410 and a set of a target value, values of parameters, user attribute data, and an execution result, which are previously accumulated in the storage unit S106. In detail, with respect to the set of the target value, the values of the parameters, the user attribute data, and the execution result, which are accumulated in the step S410, sets of identical or similar target values, values of parameters, user attribute data, and an execution result are read out, and correlation information is acquired by using the set accumulated in the step S410 and the read-out sets. Furthermore, with respect to the set of the target value, the values of the parameters, the user attribute data, and the execution result, which are accumulated in the step S410, if sets of identical or similar target values, values of parameters, user attribute data, and an execution result are not stored in the storage unit 106, the calculation of correlation information is not performed.

(Step S412) The correlation acquiring unit 107 accumulates the correlation information acquired in the step S411 in a storage medium (not shown), such as a memory, a hard disk, or the like. Furthermore, in the case where correlation information with respect to a same target value is already accumulated, correlation information is added so that the newest correlation information may be specified. When correlation information is added, previous unnecessary correlation information may be deleted. Furthermore, if correlation information is not acquired in the step S411, the present step is omitted and the operation proceeds back to the step S401.

Furthermore, in the flowchart shown in FIG. 4, a processing sequence from the step S401 to the step S403 may be suitably modified.

Furthermore, the step S410 may be performed at any step after the step S404.

Furthermore, the step S411 and the step S412 may be performed between the step S405 and the step S406.

Furthermore, in the step S410, if a difference between a target value and an execution result is not in a predetermined range, the target value, values of parameters, user attribute data, and the execution result may not be accumulated in the storage unit 106.

Furthermore, in the step S405, in the case where it is determined whether to output assist information or not based on whether a difference between a target value and an execution result is in a predetermined range or not and in the case where output is terminated in the step S409, the operation may proceed back to the step S401 without accumulating the target value, values of parameters, user attribute data, and the execution result in the storage unit 106.

Furthermore, in the step S410, a target value, values of parameters, user attribute data, and the execution result may not be accumulated in the storage unit 106 based on user attribute data representing, for example, a number of years of experience of a user.

Furthermore, in the flowchart shown in FIG. 4, the operation is terminated by power off or interruption of terminating operation.

Hereinafter, detailed operations of an information processing device according to the present embodiment will be described. Here, a case in which the manufacturing device 200 is a plasma CVD device as shown in FIG. 3 will be described. Here, for convenience of explanation, a case in which a target value, values of parameters, and an execution result are input via an input interface or the like will be described. Furthermore, a case of not using user attribute data will be first described herein. Furthermore, values, such as numbers, used in the present embodiment are values for convenience of explanation and are different from actual data. Furthermore, calculated values such as calculated correlation coefficients are also values for convenience of explanation and do not necessarily match with values calculated based on data in the present embodiment.

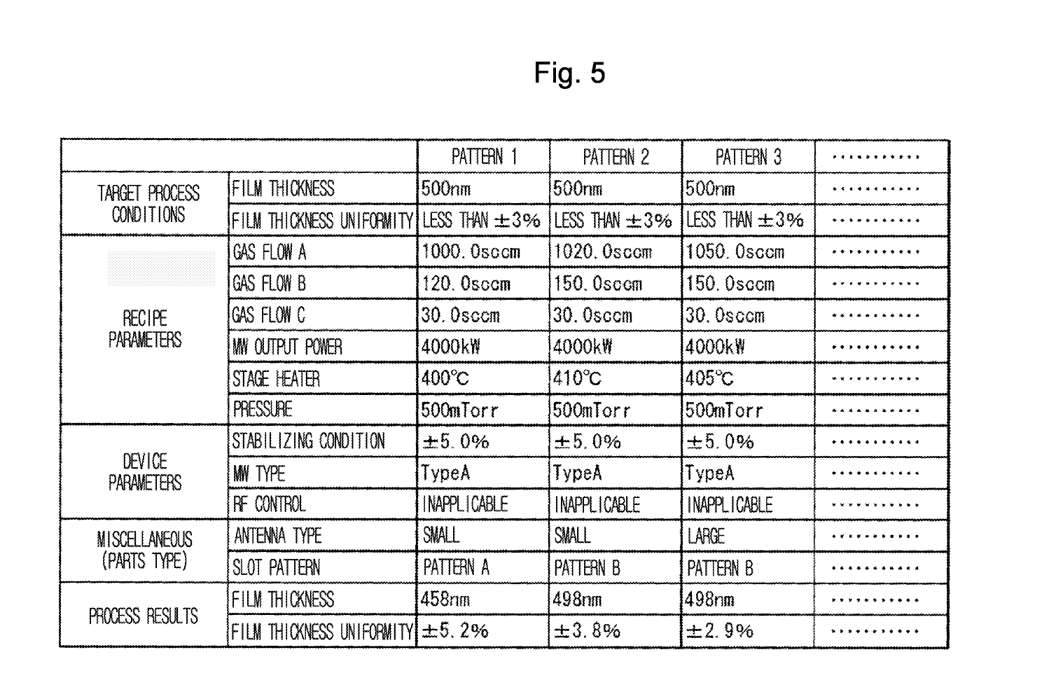

FIG. 5 is a management table for managing sets of target values, values of parameters, and execution results that are stored in the storage unit 106. In FIG. 5, the term “target process condition” corresponds to the target value described above. Here, two target values corresponding to “film thickness,” which indicates the thickness of a film to be formed, and “film thickness uniformity,” which indicates the uniformity of the thickness of the film are present. The terms “recipe parameters,” “device parameters,” and “miscellaneous (parts type)” correspond to the parameters described above. Recipe parameters are parameters that may be set up as a recipe, where a gas flow, MW output (microwave power (W)), output of a stage heater, and the like are designated. The term “device parameters” refers to parameters pre-set with respect to a device, where parameters, such as “stabilizing condition,” “MW type,” or the like, indicating a control method or a control condition for controlling a device based on a recipe or the like are designated. Furthermore, the term “miscellaneous (parts type)” indicates parameters indicating configuration of the manufacturing device 200, where “antenna type,” which indicates a type of a slot antenna for generating plasma, a “slot pattern,” which indicates a pattern of the slot antenna, or the like is designated. The parameter “antenna type” has a value indicating the size of the slot antenna, such as “small”, “large”, or the like. Furthermore, the parameter “slot pattern” has a value indicating a pattern of a slot antenna, such as “pattern A,” “pattern B,” and so on. The term “process result” corresponds to the execution result described above. The “process result” is an actually measured value of the same item as that of the “target process condition,” with respect to a film actually formed by operating the manufacturing device 200 based on parameters indicated by the “recipe parameters,” “device parameters,” and “miscellaneous (parts type).” Same as the “target process conditions,” the “process result” includes items of “film thickness,” and “film thickness uniformity.”Furthermore, each of columns indicated here by “pattern 1,” “pattern 2,” and so on corresponds to each of sets of target values, parameters, and execution results.

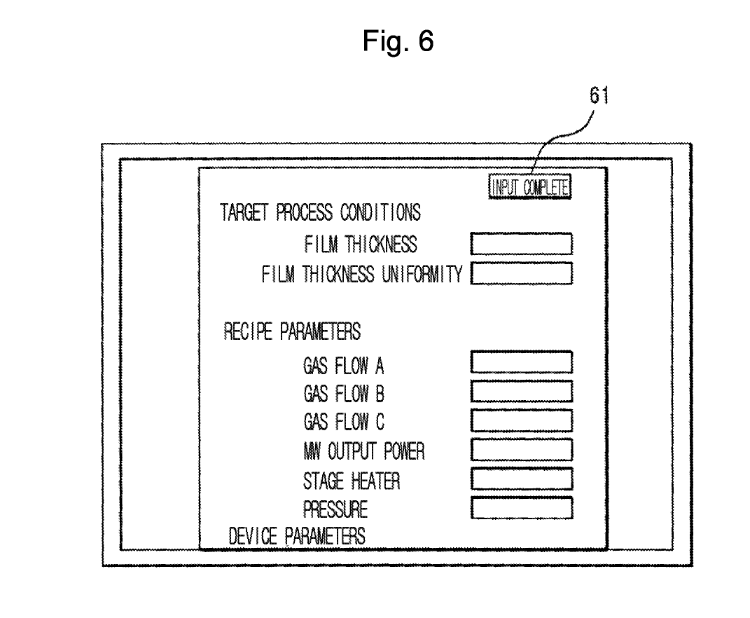

First, when a user selects a menu for inputting target values, values of parameters, and execution results by using a keyboard, a mouse, or the like, as shown in FIG. 6, an input interface screen for inputting a target value, values of parameters, and an execution result is displayed.

Next, the user inputs target values, values of parameters, and execution results by operating a mouse, a keyboard, or the like. Furthermore, it is assumed that execution results are values acquired by measuring a film thickness or a film thickness uniformity of a film actually formed in the manufacturing device 200 by using an examination device (not shown) or the like. Furthermore, values of parameters input here may be transmitted to the manufacturing 200, and the manufacturing device 200 may perform manufacturing processes based on the values of the parameters.

Next, if the user presses an “input complete” button 61 shown in FIG. 6 by using a mouse or the like or selects an input complete item in a menu or the like, the assist information acquiring unit 108 determines whether differences between each of the input target values and each of input execution results are in a predetermined range or not. If it is determined that the differences are not in the predetermined range, the assist information acquiring unit 108 begins to acquire assist information.

Here, a process in which the correlation acquiring unit 107 acquires correlation information will be described in detail.

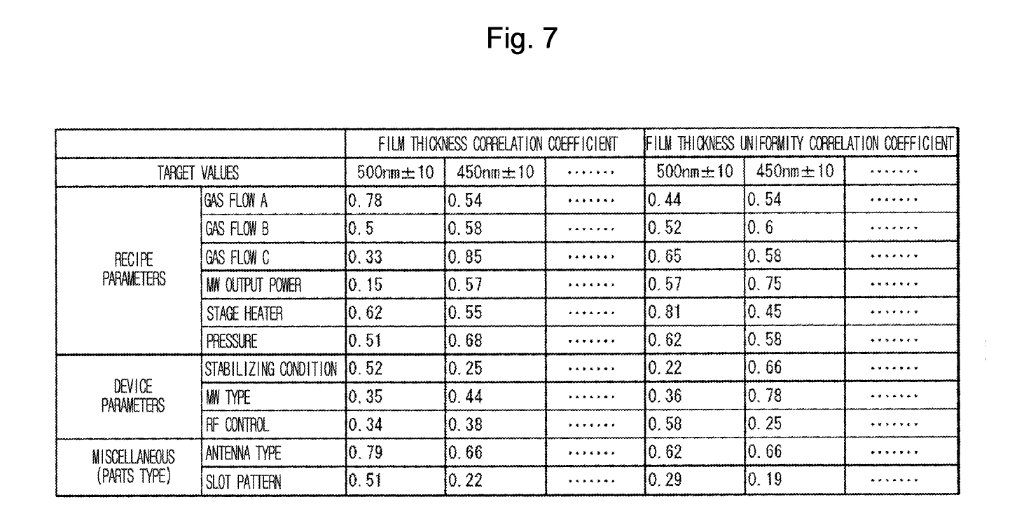

FIG. 7 is a diagram showing correlation information acquired by the correlation acquiring unit 107. First, the correlation acquiring unit 107 reads out data of sets with identical or similar “film thickness,” which is one of target values, from data of one or more sets of target values, values of parameters, and execution results stored in the storage unit 106 as shown in FIG. 5. For example, it is configured in advance to determine that target values of “film thickness” are the same if a difference between film thicknesses is below 5 nm. Alternatively, only sets with identical film thicknesses may be read out. Then, differences between a target value of “film thickness” and an execution result of “film thickness” is calculated with respect to each of the read-out sets. Then, a plurality of combinations of calculated differences with a parameter “gas flow A,” which is one of a plurality of parameters, are acquired. Then, from the plurality of combinations of calculated differences between the target value of “film thickness” and the execution result of “film thickness” with the values of “gas flow A,” a correlation coefficient between a difference between the target value of “film thickness” and the execution result of “film thickness” and a parameter “gas flow A” is calculated. Furthermore, in the same manner, correlation coefficients between a difference between the target value of “film thickness” and the execution result of “film thickness” and parameters other than the parameter “gas flow A,” such as “gas flow B” and the like, are calculated. Furthermore, absolute values of correlation coefficients are calculated herein. The values of an item “film thickness correlation coefficients” shown in FIG. 7 show results of the calculations according to types of parameters. Here, it is assumed that a parameter with high correlation coefficient has high correlation with a difference between a target value of “film thickness” and an execution result of “film thickness.” Furthermore, in the same manner, the values of an item “film thickness uniformity correlation coefficients” shown in FIG. 7 show results of the calculation of correlation coefficients with respect to “film thickness uniformity” according to types of parameters. However, it is assumed here that “film thickness uniformity” is calculated by using only data of sets with the identical value for “film thickness uniformity.” The process of calculating this correlation information is performed every time a set of a target value, values of parameters, and an execution result is accumulated, and the acquired correlation information is added and accumulated in a storage medium, such as a hard disk or a memory, in order for a user to recognize the newest correlation information. Furthermore, correlation information is configured for each set with identical or similar target values. For example, in FIG. 7, respective values of the items “film thickness correlation coefficients” and “film thickness uniformity correlation coefficients” are calculated for each set with similar target values. Since a method of calculating a correlation coefficient is well-known in the art, detailed description thereof will be omitted. Furthermore, non-numeric values of parameters may be replaced with suitable numbers and correlation coefficients may be calculated based on the replaced values.

First, the assist information acquiring unit 108 acquires a value of the “film thickness,” which is one of target values currently input to a screen as shown in FIG. 6 for inputting target values or the like, and searches for correlation information corresponding to a “film thickness” identical or similar to the value of the “film thickness” from among correlation information as shown in FIG. 7. Here, only correlation information corresponding to a “film thickness” identical to the value of the “film thickness” may be searched for. Here, if the currently input value of the “film thickness” is 500 nm, “film thickness correlation coefficient” corresponding to a target value including the value is detected. Here, a column of “film thickness correlation coefficients” corresponding to “target values” of “500 nm±10” in the correlation information shown in FIG. 7 is detected. Then, values of correlation coefficients equal to or greater than 0.7 are detected from the column of “film thickness correlation coefficients” corresponding to “target values” of “500 nm±10,” in the correlation information shown in FIG. 7 and names of parameters corresponding to the values are acquired. Here, it is assumed that respective correlation coefficients of parameters “gas flow A” and “antenna type” are equal to or greater than 0.7, and the assist information acquiring unit 108 has acquired the names of parameters “gas flow A” and “antenna type.”

Next, data of sets in which values of “film thickness,” which is one of target values, are identical or similar to the current target value of “film thickness” is read out from data of one or more sets of target values, values of parameters, and execution results stored in the storage unit 106 as shown in FIG. 5. Here, only data of sets in which values of “film thickness,” which is one of target values, are identical to the current target value of “film thickness” may be read out. Then, differences between target values and execution results of “film thickness” are calculated with respect to the read out data, and one or more sets of target vales, values of parameters, and execution results are determined from a set with the smallest difference between target values and execution results with respect to “film thickness” in an ascending order of the differences between target values and execution results. Here, it is assumed that three sets are determined, for example.

From among the determined sets, values of parameters corresponding to the names of parameters “gas flow A” and “antenna type” acquired from correlation information are acquired.

For example, if it is assumed here that a set of “pattern 3” as shown in FIG. 5 from among sets in which target values of “film thickness” are “500 nm±10” has the smallest difference between a target value and an execution result with respect to “film thickness,” the assist information acquiring unit 108 acquires a value “1050.00 sccm” of “gas flow A” and a value “large” of “antenna type” of the pattern 3.

The assist information acquiring unit 108 generates assist information. The assist information is information for indicating parameters and values of the parameters set by a user who acquires more precise film thickness, with respect to the current target value.

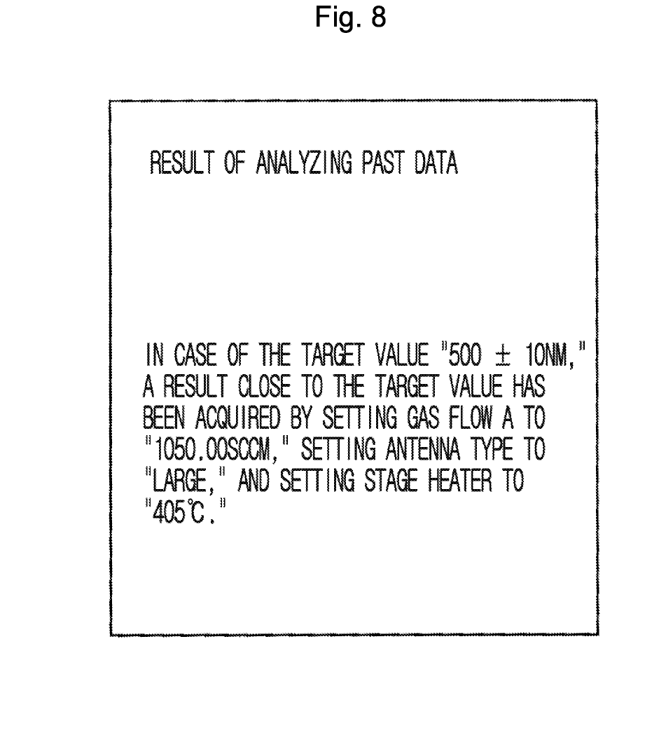

Furthermore, in the same manner, the assist information acquiring unit 108 generates assist information with respect to “film thickness uniformity,” which is one of currently input target values, and acquires assist information as shown in FIG. 8 by combining the generated assist information.

The output unit 109 displays assist information as shown in FIG. 8 on a screen (not shown), such as a monitor.

Here, since a difference between a target value and an execution result is out of a predetermined range, the accumulation unit 105 does not accumulate a set of the current target value, values of parameters, and an execution result in the storage unit 106.

Here, at the moment when a user presses the “input complete” button shown in FIG. 6 by using a mouse or the like or selects an input complete item in a menu or the like, the assist information acquiring unit 108 determines that a difference between each of the input target values and each of input execution results is not in a predetermined range.

In this case, the assist information acquiring unit 108 does not acquire assist information, and the accumulation unit 105 accumulates a set of the current target value, values of parameters, and an execution result in the storage unit 106.

With respect to newly accumulated sets of target values, values of parameters, and execution results, the correlation acquiring unit 107 reads out sets with identical or similar target values and acquires correlation information with respect to the read-out sets as described above. Then, correlation information corresponding to the identical target value is overwritten by and updated with the acquired correlation information.

Next, detailed description on embodiments using user attribute data will be described.

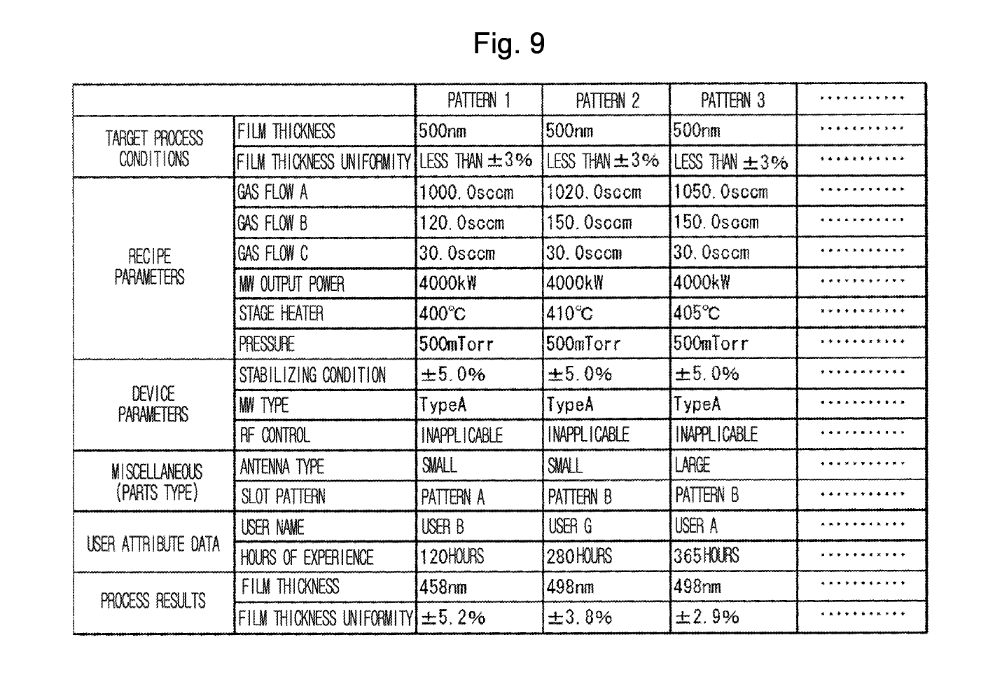

FIG. 9 is a management table for managing sets of target values, values of parameters, user attribute data, and execution results that are stored in the storage unit 106. User attribute data is attribute data of a user who has input target values or the like. Here, user attribute data includes an item “username,” which indicates the name of a user, and an item “experience time,” which indicates a total period of time for which the user has used the manufacturing device 200. The management table of FIG. 9 is identical to that of FIG. 5 except the user attribute data.

First, when a user selects a menu for inputting target values, values of parameters, user attribute data, and execution results by using a keyboard or a mouse, an input screen obtained by adding the input items “username” and “experience time” of user attribute data to the input screen shown in FIG. 6 is displayed. The input items correspond to the items of the management table of FIG. 9.

Here, although the process in which the correlation acquiring unit 107 acquires correlation information is basically identical to that in the case without using user attribute data, values for sets with values of “experience time” of user attribute data less than a predetermined value, for example, “200 hours” from among sets of target values, values of parameters, user attribute data, and execution results are not used for calculation of correlation coefficients. In other words, the correlation acquiring unit 107 reads out sets with the identical or similar “film thickness,” which is one of target values, and with values of “experience time” of user attribute data above “200 hours” from one or more sets of target values, values of parameters, user attribute data, and execution results, which are stored in the storage unit 106 as shown in FIG. 9. For example, the correlation acquiring unit 107 does not read out the pattern 1 or the like. Generally, values of parameters set by a user corresponding to relatively short period of time for using a manufacturing device, that is, a user with less experience, may not be referred, even if a result based on the parameters is in a high precision. Therefore, by acquiring a correlation coefficient or the like by excluding combinations of values of parameters of such a user by using user attribute data, only combinations of suitable values of parameters backed up by experiences may be reflected to assist information, and thus assist information of high quality may be provided.

Next, when a user inputs target values, values of parameters, and execution results by operating a mouse or a keyboard, and the user completes the input, the assist information acquiring unit 108 determines whether differences between each of the input target values and each of input execution results are in a predetermined range or not. If it is determined that the differences between each of the input target values and each of input execution results are not in the predetermined range, the assist information acquiring unit 108 begins to acquire assist information.

Here, same as the correlation acquiring unit 107, the assist information acquiring unit 108 also does not use values of sets with values of “experience time” of user attribute data less than a predetermined value, for example, “200 hours”, from among the sets of target values, values of parameters, user attribute data, and execution results, in the calculation of correlation coefficients. The remaining operations of the assist information acquiring unit 108 are identical to those in the case not using user attribute data.

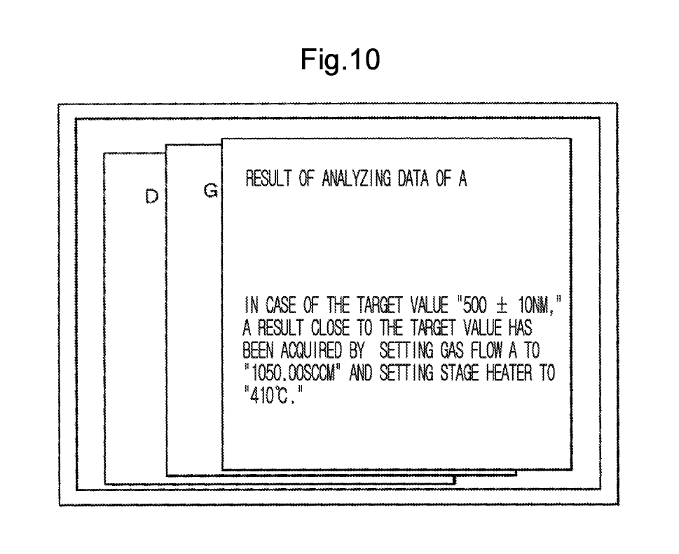

A display example of assist information generated as described above is shown in FIG. 10. For example, “username” acquired from a set of a target value with respect to “film thickness”, which has the smallest difference with an execution result, values of parameters, user attribute data, and the execution result, are displayed.

Furthermore, although a case in which the manufacturing device 200 is a plasma CVD device is described in the present embodiment, the manufacturing device 200 may be another manufacturing device 200, and may be an organic film forming device, for example.

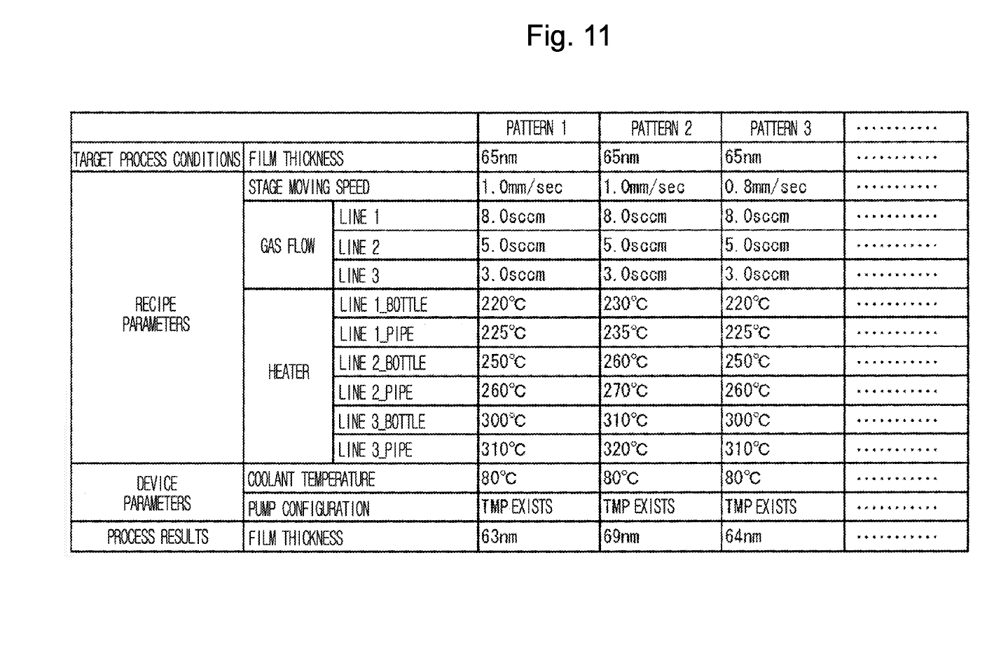

FIG. 11 shows an example of a management table for managing sets of target values, values of parameters, user attribute data, and execution results, which are stored in the storage unit 106 of the information processing device 10, in the case where the manufacturing device 200 is an organic film forming device as shown in FIG. 14A.

According to the present embodiment, by acquiring assist information regarding types of parameters with high correlation with respect to a current target value from correlation information regarding correlation among target values, values of parameters, and execution results and outputting the assist information, parameters to be adjusted for acquiring an execution result close to the current target value, values of the parameters, or the like may be shown to a user, and thus adjustment of values of parameters may be performed efficiently and quickly.

Furthermore, since target values, values of parameters, and execution results are sequentially accumulated and reflected to correlation information, more precise assist information may be provided to a user.

Furthermore, by using user attribute data when correlation information or assist information is acquired, experiences or the like of a user who has set values of parameters or the like may be reflected to assist information, and only proven assist information based on experiences may be provided to a user.

Furthermore, according to the present embodiment, assist information is output after target values, values of parameters, and execution results are received or acquired. However, in the present invention, assist information may be acquired and displayed at the moment when a user inputs target values.

Furthermore, in each of the above embodiments, each process (each function) may be performed by a single device (single system) in a concentrated fashion or may be performed by a plurality of devices or a plurality of systems in a distributed fashion.

In each of the above embodiments, two or more communication means (receiving units or acquiring units) existing in a single device may physically be realized as a single device.

Although an information processing device is a stand alone unit in each of the above embodiments, the information processing device may be a server device of a server & client system. In the latter case, an output unit or a receiving unit may receive an input through a communication line or may output a screen.

Furthermore, in each of the above embodiments, each component may be realized in dedicated hardware or a component that can be realized in software may be realized by executing a program. For example, a program executing unit like a MPU may read and execute software and a program recorded on a recording medium such as a hard disk or a semiconductor memory, and thereby each component may be realized.

Furthermore, software realizing the information processing device in each of the above embodiments is a program as described below. In other words, the program is a program for operating a computer as a target value receiving unit, which receives one or more types of target values indicating targets in a predetermined semiconductor manufacturing process performed with respect to a target substrate by using a manufacturing device, a parameter acquiring unit, which acquires values of one or more types of parameters with respect to the manufacturing device for performing the semiconductor manufacturing process, an execution result acquiring unit, which acquires one or more types of execution results indicating results of performing the semiconductor manufacturing process, an accumulation unit, which associates the execution results acquired by the execution result acquiring unit, the target values received by the target value receiving unit, and the values of the parameters acquired by the parameter acquiring unit with one another and accumulates the same, a correlation acquiring unit, which acquires correlation information regarding correlations among the execution results, the target values, and the values of the parameters accumulated by the accumulation unit, an assist information acquiring unit, which acquires assist information related to parameters with high correlation with respect to the target values received by the target value receiving unit, by using the correlation information acquired by the correlation acquiring unit, and an output unit, which outputs the assist information acquired by the assist information acquiring unit.

Furthermore, in the program, functions embodied by the program do not include functions that may be embodied only in hardware. For example, functions that may be embodied only in hardware, such as a modem or an interface card in an acquiring unit for acquiring information or an output unit for outputting information, are not included in the functions embodied by the program.

A single computer or a plurality of computers may execute the program. That is, the program may be executed in a concentrated or distributed fashion.

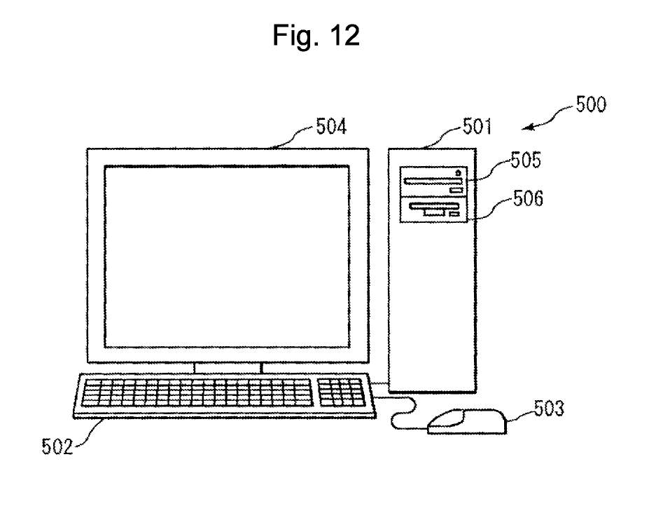

FIG. 12 is a schematic diagram showing the appearance of a computer system for implementing the information processing device according to above embodiment by executing the program. The embodiment is realized by computer hardware and a computer program executed thereon.

In FIG. 12, a computer system 500 includes a computer 501 including a CD-ROM (Compact Disk Read Only Memory) drive 505 and a FD (flexible disk) drive 506, a keyboard 502, a mouse 503, and a monitor 504.

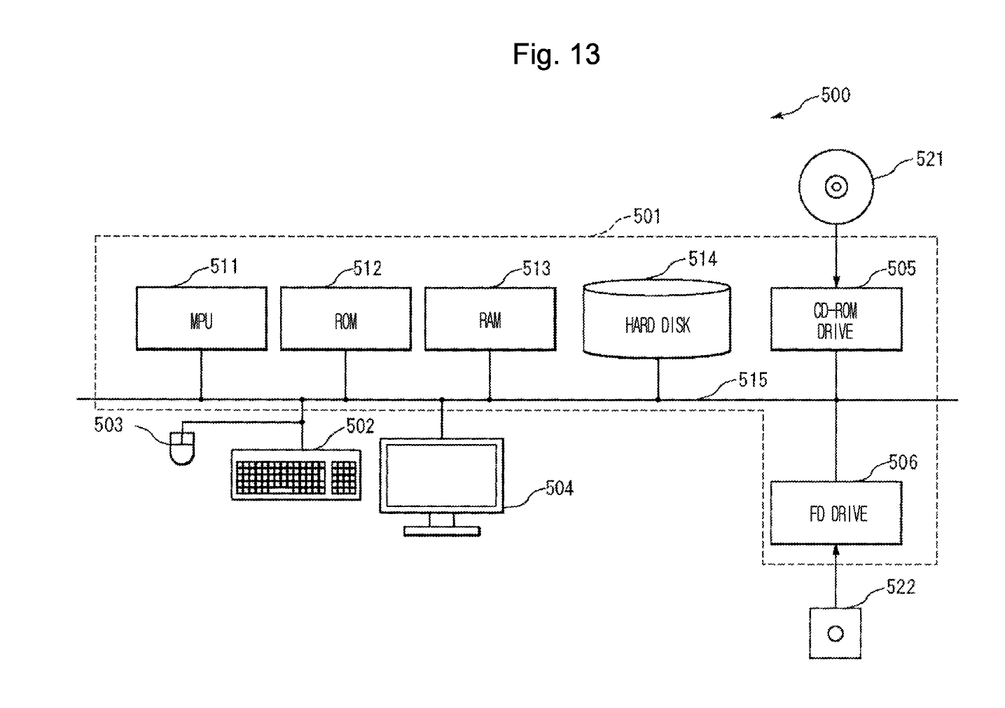

FIG. 13 is a block diagram of the computer system. Referring to FIG. 13, the computer 501 includes, in addition to the CD-ROM drive 505 and the FD drive 506, a MPU (micro processing unit) 511, a ROM (read only memory) 512 for storing a program such as a boot-up program, a RAM (random access memory) 513 that is connected to the MPU 511 and temporarily stores instructions of an application program and provides a temporal storage space, a hard disk 514 that stores the application program, a system program, and data, and a bus 515 which connects the MPU 511, the ROM 512, and the like to one another. The computer 501 may include a network card (not shown) used to connect a LAN.

In the computer system 500, a program executing a function of the information processing device according to above embodiments may be stored in a CD-ROM 521 or an FD 522, may be inserted into the CD-ROM drive 505 or the FD drive 506, and may be transmitted to the hard disk 514. Alternatively, the program may be transmitted to the computer 501 over a network (not shown) and be stored in the hard disk 514. The program is loaded to the RAM 513 upon execution. The program may be directly loaded from the CD-ROM 521, the FD 522, or the network.

The program may or may not include an operating system (OS) for executing the function of the information processing device according to above embodiments, a third party program, or the like. The program may include an instruction part used to obtain a desired result by calling a controlled proper function (module). The operation of the computer system 500 is well known and thus a detailed description thereof will not be given here.

While the present invention has been particularly shown and described with reference to exemplary embodiments thereof, it will be understood by those of ordinary skill in the art that various changes in form and details may be made therein.

### INDUSTRIAL APPLICABILITY

As described above, an information processing device or the like according to the present invention is suitable as a device for setting values of parameters for a semiconductor manufacturing device or the like, and more particularly, is useful as a device for setting values of parameters based on target values.

1. An information processing device comprising:
a target value receiving unit which receives one or more types of target values indicating targets in a predetermined semiconductor manufacturing process performed with respect to a target substrate by using a manufacturing device;
a parameter acquiring unit which acquires values of one or more types of parameters with respect to the manufacturing device for performing the semiconductor manufacturing process;
an execution result acquiring unit which acquires one or more types of execution results indicating results of performing the semiconductor manufacturing process;
an accumulation unit which associates the execution results acquired by the execution result acquiring unit, the target values received by the target value receiving unit, and the values of the parameters acquired by the parameter acquiring unit with one another and accumulates the same;
a correlation acquiring unit which acquires correlation information indicating correlations among the execution results, the target values, and the values of the parameters accumulated by the accumulation unit;
an assist information acquiring unit which acquires assist information related to parameters with high correlation with respect to the target values received by the target value receiving unit, by using the correlation information acquired by the correlation acquiring unit; and
an output unit which outputs the assist information acquired by the assist information acquiring unit.

2. The information processing device of claim 1, wherein the parameter acquiring unit acquires values of a plurality of types of parameters;
the accumulation unit accumulates a plurality of sets of the execution results acquired by the execution result acquiring unit, the target values received by the target value receiving unit, and the values of the plurality of types of parameters acquired by the parameter acquiring unit, wherein the execution results, the target values, the values of the plurality of types of parameters are associated with one another;
the correlation acquiring unit acquires a value indicating a difference between a target value and an execution result from each of the plurality of sets of the execution results, the target values, and the values of the plurality of types of parameters accumulated by the accumulation unit, and calculates the correlation information, which is a correlation coefficient between each of the values of the plurality of parameters and the value indicating the difference, by using a plurality of sets of the acquired value indicating the difference and values of a plurality of parameters corresponding to the value indicating the difference; and
the assist information acquiring unit acquires assist information regarding one or more parameters with large correlation coefficients from among the plurality of parameters.

3. The information processing device of claim 2, wherein the assist information acquiring unit acquires the assist information which is the values of the one or more parameters with large correlation coefficients, that is, values of parameters corresponding to small differences between target values and execution results, from the values of the parameters accumulated by the accumulation unit.

4. The information processing device of claim 1, further comprising a user attribute acquiring unit which acquires user attribute data that is a value indicating an attribute of a user who performs the semiconductor manufacturing process,
wherein the accumulation unit associates the user attribute data with the execution results and accumulates the user attribute data, and the correlation acquiring unit acquires the correlation information by using the user attribute data.

5. The information processing device of claim 4, wherein the assist information acquiring unit acquires the assist information by using the user attribute data.

6. The information processing device of claim 1, further comprising a user attribute acquiring unit which acquires user attribute data that is a value indicating an attribute of a user who performs the semiconductor manufacturing process,
wherein the accumulation unit associates the user attribute data with each of the sets of the execution results, the target values, and the values of the plurality of parameters and accumulates the user attribute data, and
the correlation acquiring unit selects a plurality of sets of the execution results, the target values, and the values of the plurality of parameters, which are to be used to calculate the correlation coefficients, from the plurality of sets of the execution results, the target values, and the values of the plurality of parameters accumulated by the accumulation unit, by using the user attribute data corresponding to each of the plurality of sets, and calculates the correlation coefficients by using the selected sets.

7. The information processing device of claim 6, wherein the assist information acquiring unit acquires the assist information which is the values of the one or more parameters with large correlation coefficients, that is, values of the parameters corresponding to small differences between target values and execution results, from the values of the parameters selected from among the values of the parameters accumulated by the accumulation unit by using the user attribute data in association with the values of the parameters.

8. An information processing method, which is performed by using a target value receiving unit, a parameter acquiring unit, an execution result acquiring unit, an accumulation unit, a correlation acquiring unit, an assist information acquiring unit, and an output unit, the information processing method comprising:
a target value receiving step, in which the target value receiving unit receives one or more types of target values indicating targets in a predetermined semiconductor manufacturing process performed with respect to a target substrate by using a manufacturing device;
a parameter acquiring step, in which the parameter acquiring unit acquires values of one or more types of parameters with respect to the manufacturing device for performing the semiconductor manufacturing process;
an execution result acquiring step, in which the execution result acquiring unit acquires one or more types of execution results indicating results of performing the semiconductor manufacturing process;
an accumulation step, in which the accumulation unit associates the execution results acquired in the execution result acquiring step, the target values received in the target value receiving step, and the values of the parameters acquired in the parameter acquiring step with one another and accumulates the same;
a correlation acquiring step, in which the correlation acquiring unit acquires correlation information indicating correlations among the execution results, the target values, and the values of the parameters accumulated in the accumulation step;
an assist information acquiring step, in which the assist information acquiring unit acquires assist information related to parameters with high correlation with respect to the target values received in the target value receiving step, by using the correlation information acquired in the correlation acquiring step; and
an output step, in which the output unit outputs the assist information acquired in the assist information acquiring step.

9. A program for operating a computer as:
a target value receiving unit which receives one or more types of target values indicating targets in a predetermined semiconductor manufacturing process performed with respect to a target substrate by using a manufacturing device;
a parameter acquiring unit which acquires values of one or more types of parameters with respect to the manufacturing device for performing the semiconductor manufacturing process;
an execution result acquiring unit which acquires one or more types of execution results indicating results of performing the semiconductor manufacturing process;
an accumulation unit which associates the execution results acquired by the execution result acquiring unit, the target values received by the target value receiving unit, and the values of the parameters acquired by the parameter acquiring unit with one another and accumulates the same;
a correlation acquiring unit which acquires correlation information indicating correlations among the execution results, the target values, and the values of the parameters accumulated by the accumulation unit;
an assist information acquiring unit which acquires assist information related to parameters with high correlation with respect to the target values received by the target value receiving unit, by using the correlation information acquired by the correlation acquiring unit; and
an output unit, which outputs the assist information acquired by the assist information acquiring unit.
